(19) United States
(12) Patent Application Publication
(10) Pub. No.: US 2007/0091024 A1
(43) Pub. Date: Apr. 26, 2007

(54) CIRCUIT AND METHOD FOR RESETTING PLASMA DISPLAY PANEL

(76) Inventor: Chi-Hsiu Lin, Yunlin County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,934

(22) Filed: Nov. 4, 2005

(30) Foreign Application Priority Data
Oct. 24, 2005 (TW) 94137112

(51) Int. Cl. G09G 3/28

(52) U.S. Cl. 345/68

(57) ABSTRACT

A circuit and a method for resetting a plasma display panel (PDP) are provided. The circuit resets at least one display unit in the PDP at a resetting period. The circuit includes at least one energy recovery circuit (ERC). In a first period of the resetting period, the ERC provides discharge energy to a first terminal of the display unit through resonance. Meanwhile, a second terminal of the display unit electrically connects to a first fixed voltage.

### CROSS-REFERENCE TO RELATED APPLICATION

This application claims the priority benefit of Taiwan application serial no. 94137112, filed on Oct. 24, 2005. All disclosure of the Taiwan application is incorporated herein by reference.

### BACKGROUND OF THE INVENTION

1. Field of the Invention

The present invention relates to a plasma display panel. More particularly, the present invention relates to a circuit and a method for resetting a plasma display panel.

2. Description of the Related Art

Plasma display panel (PDP) operates by producing a gaseous discharge to light up a fluorescent agent. Therefore, a PDP is also referred to as a gas discharge display. In genera, a PDP has a plurality of display units as shown in FIG. 1. FIG. 1 is a schematic diagram showing a conventional plasma display panel. The plasma display panel 100 in FIG. 1 has a plurality of scan electrodes S1˜Sn, a plurality of bulk electrodes B1˜Bn and a plurality of addressing electrodes A1˜Am. The bulk electrodes B1˜Bn are also called the sustain electrodes. The scan electrodes S1˜Sn and the bulk electrodes B1˜Bn are aligned inter-digitatedly in parallel. The addressing electrodes A1˜Am are aligned vertically with both of the scan electrodes S1˜Sn and the bulk electrodes B1˜Bn. The addressing electrodes A1˜Am, the scan electrodes S1˜Sn and the bulk electrodes B1˜Bn are isolated from one another. The blocks intersected by the addressing electrodes A1˜Am in the vertical direction and the scan electrodes S1˜Sn and the bulk electrodes B1˜Bn in the horizontal direction are display units (for example, the display unit 110 in FIG. 1). Each display unit 110 is bounded by two glass panels on the top and the bottom and by the isolating panels at the front, rear, left and right sides to form a discharge space.

In the process of driving the plasma display panel, a resetting period, an addressing period and a sustaining period are sequentially executed in cycles. In general, the addressing period is also known as a scanning period. Each display unit can have a light-emitting state and a non-emitting state. For example, after all the display units of the PDP 100 have been reset (in the resetting period), whether the display unit 110 lights up or not has already been determined through the addressing by the addressing electrode A2 and the scan electrode Sn (in the addressing period). After the addressing period, the sustaining period is immediately executed. If the display unit 110 has been set to emit light through the addressing, it continues to emit in the sustaining period. During the sustaining period, the scan electrode Sn and the bulk electrode Bn transmit sustaining voltage to each other so that these two electrodes produces alternating current discharge within the discharge space of the display unit 110. The UV light generated by discharge bombard against the fluorescent material within the discharge space to produce visible light.

FIG. 2 is a diagram showing a circuit used for driving the scanning side and the bulk side of a conventional plasma display panel. In FIG. 2, the display unit 110 and its associated circuits are used to illustrate a typical display unit and related driving circuit in the PDP 100. The capacitor Cp represents an equivalent capacitor between the scan electrode Sn and the bulk electrode Bn of the display unit 110. In the addressing period and the sustaining period, the switches SW9 and SW 12 are turned off while the switches SW10 and SW11 are turned on.

FIG. 3 is a diagram showing the on-off timing relation of the switches SW1˜SW12 shown in FIG. 2 and the voltage Vp of the display unit during the sustaining period. In the sustaining period, the sustaining circuit 210 on the scanning side and the sustaining circuit 230 on the bulk side alternately transmit a sustain voltage Vs to the two terminals of the capacitor Cp in the display unit 110 through the scan electrode and the bulk electrode. Hence, the scan electrode and the bulk electrode are able to generate an alternating discharge current in the discharge space within the display unit 110. The UV light generated by discharge bombard against the fluorescent material within the discharge space to produce visible light.

In general, the sustaining voltage Vs is set to a sufficiently high potential (typically, between 170˜200 V). To reduce the power loss resulted from a switching of the switches SW3 and SW4 (or the switches SW5 and SW6), energy recovery circuits 220 and 240 (ERC) are set up on the scan side and the bulk side respectively. In the positive discharging period, before the switch SW3 is turned on, the weak discharge energy stored inside the capacitor Css of the energy recovery circuit 220 will be released to the display unit 110 through the switch SW1, the diode D1 and the inductor L. Using the resonance between the capacitor Cp and the inductor L, the released weak discharge energy drives the display unit voltage Vp at a predetermined ramp voltage. Thus, power loss resulting from a large voltage difference when the switch SW3 is turned on is minimized. After turning the switch SW3 off, the switch SW2 begins to turn on. As a result, the energy within the capacitor Cp is returned to the capacitor Css through the inductor L, the diode D2 and the switch SW2. In the negative discharge period, the sustain circuit 230 on the bulk side operates is similar to the sustain circuit 210 on the scan side. Hence, a detailed description is omitted.

FIG. 4 is a diagram showing the on-off timing relation of the switches SW1˜SW12 shown in FIG. 2 and the voltage Vp of the display unit during the resetting period. In the resetting period, the switches SW10 and SW11 of the reset circuit 200 are turned off. In other words, the sustain circuit 210 on the scan side will not provide any signal to the display unit 110 during this period. During the resetting period, the scan side and the bulk side of the display unit 110 are reset in sequence. To reset the scan side, the switches SW9 and SW5 are turned on so that the reset voltage Vd (greater than the sustain voltage Vs) can pass through the switch SW9 and the resistor R and charge up the capacitor Cp slowly. Thus, a weak discharge is produced to erase the wall charge and reset the display. Because all the display units in the plasma display panel are reset simultaneously with the application of the reset voltage Vd, all the display units on the PDP will be emitted during this period to produce the so-called ‘background’ light. The background light is not a normal image. Since it is necessary to produce a weak discharge for erasing wall charge and resetting the display, the slower the ramp voltage applied to the display unit the better (thereby extending the resetting period).

However, in the process of operating the plasma display panel, the lit-up background light will persist for a longer period if the resetting period is extended. Thus, the image quality of the PDP may be seriously affected. Furthermore, the longer the resetting period, the shorter time available for determining the average brightness of the display units in the sustaining period. Consequently, the peak value of the brightness of each display unit will have to be reduced. In other words, the degree of color display that can be provided by the PDP will drop significantly.

### SUMMARY OF THE INVENTION

Accordingly, at least one objective of the present invention is to provide a circuit for resetting a plasma display panel. By eliminating the redundant components of a reset circuit, the production cost of the reset circuit is reduced. Furthermore, by shortening the resetting period relative to the prior technique, the background illumination is reduced and the color display is increased.

At least a second objective of the present invention is to provide a method for resetting a plasma display panel such that the required weak discharge energy is provided to the resetting display units through an energy recovery circuit. Hence, the resetting period is shortened, the background illumination is reduced and the color display is increased.

To achieve these and other advantages and in accordance with the purpose of the invention, as embodied and broadly described herein, the invention provides a circuit for resetting at least one display unit in a plasma display panel. The reset circuit includes at least one energy recovery circuit (ERC). In a first period of the resetting period, the ERC provides weak discharge energy to a first terminal of the display unit through resonance. Meanwhile, a second terminal of the display unit electrically connects with a first fixed voltage when the display unit is in the first period of the resetting period.

From another viewpoint, the present invention also provides a method for resetting a plasma display panel. The plasma display panel comprises at least a display unit. The reset method includes providing weak discharge energy to one terminal of a display unit through the resonance in a corresponding energy recovery circuit during the first period of a resetting period. In addition, a second terminal of the display unit is made to electrically connect with a fixed voltage in the first period of the resetting period.

Accordingly, the present invention utilizes the means of resonance in an energy recovery circuit to provide weak energy discharge for resetting (erasing wall charge) to the display unit during the resetting period. Therefore, redundant components in the reset circuit can be eliminated to reduce production cost. Moreover, the time for completing a resetting operation when the energy recovery circuit provides weak discharge energy is far shorter than that of the prior technique. Hence, the background illumination can be substantially reduced and the display of colors can be increased at the same time.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional plasma display panel.

FIG. 2 is a diagram showing a circuit used for driving the scanning side and the bulk side of a conventional plasma display panel.

FIG. 3 is a diagram showing the on-off timing relation of the switches shown in FIG. 2 and the voltage of the display unit during the sustaining period.

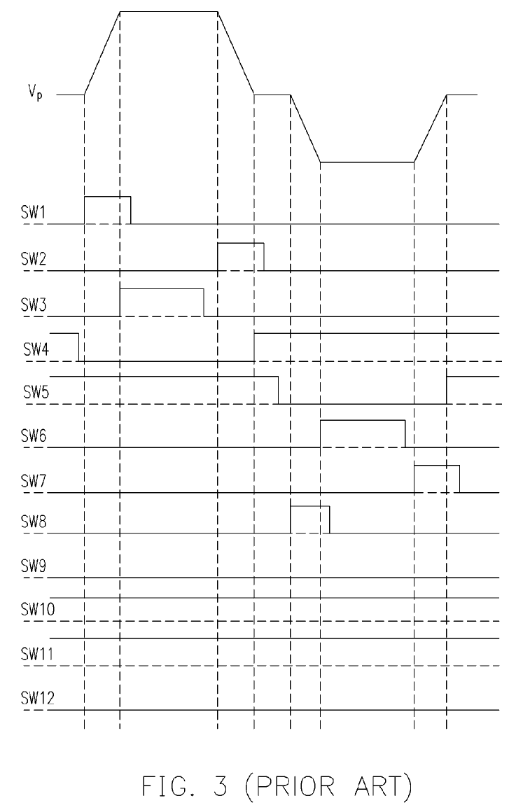

FIG. 4 is a diagram showing the on-off timing relation of the switches shown in FIG. 2 and the voltage of the display unit during the resetting period.

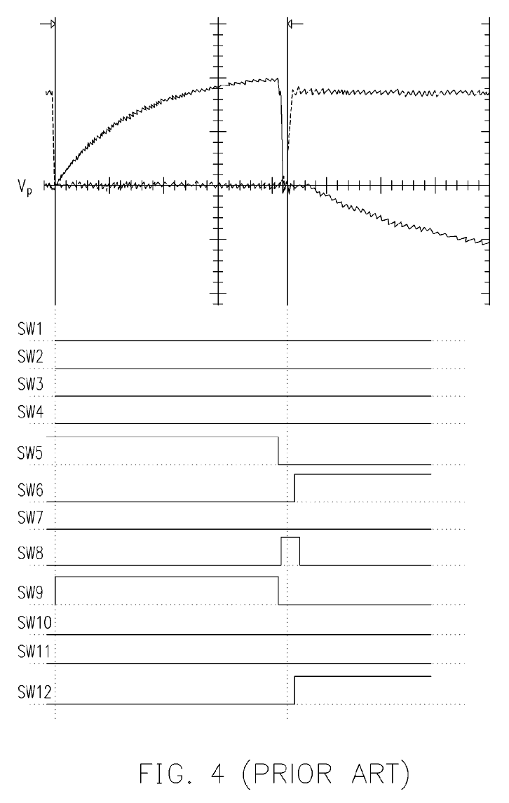

FIG. 5 is a diagram showing a circuit for driving the scan side and the bulk side of a plasma display panel according to one embodiment of the present invention.

FIG. 6 is a diagram showing the on-off timing relation of the switches and the voltage of the display unit in FIG. 5 during the resetting period according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

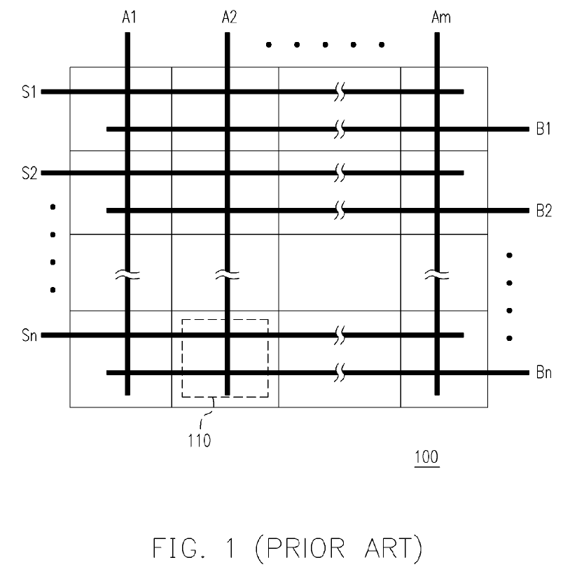

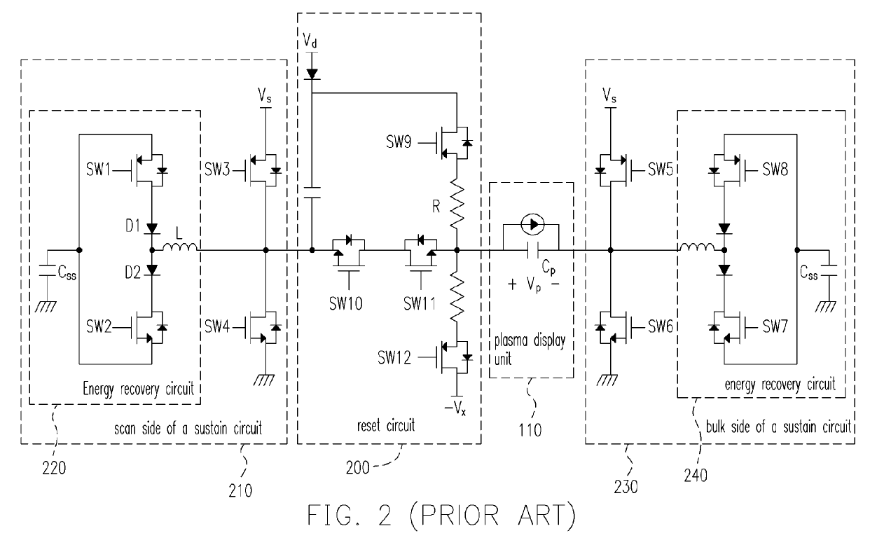

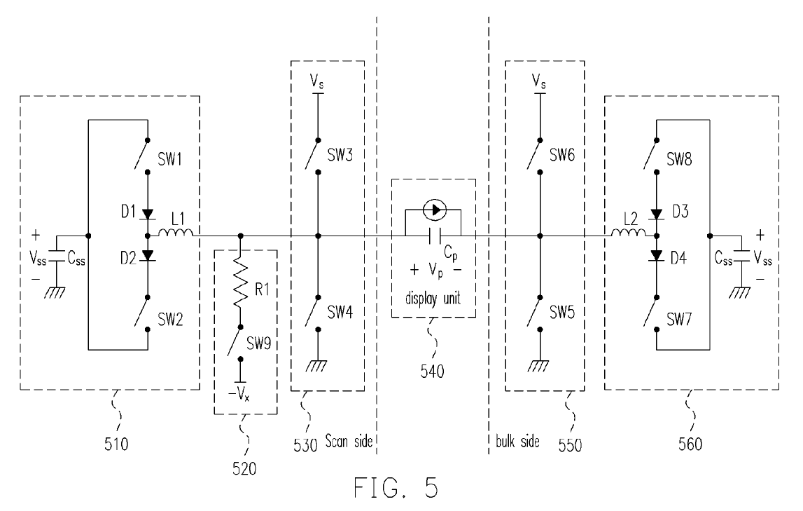

FIG. 5 is a diagram showing a circuit for driving the scan side and the bulk side of a plasma display panel according to one embodiment of the present invention. As shown in FIG. 5, a display unit 540 and related circuits electrically connected to the display unit 540 are used to describe the display units and related driving circuits of the entire plasma display panel (for example, the plasma display panel 100 in FIG. 1). The capacitor Cp represents the equivalent capacitor between the scan side electrode and the bulk side electrode of the display unit 540. Compared with the conventional technique described in FIG. 2, the present invention is able to eliminate extra reset circuits and yet achieve the function of resetting (erasing) the plasma display panel. Hence, the production cost of the circuit is reduced. In the following, the procedure for operating the circuit is explained in detail.

In the sustaining period, the sustain circuit 530 on the scan side and sustain circuit 550 on the bulk side alternately transmit a sustain voltage Vs to the two terminals of the capacitor Cp in the display unit 540 through the scan electrode and the bulk electrode. Hence, the two electrodes generate an alternating discharge current inside the discharge space of the display unit 540. The UV light generated by discharge bombard against the fluorescent material within the discharge space to produce visible light.

To reduce the energy loss resulting from the switching of the switches SW3 and SW4 (or the switches SW5 and SW6), energy recovery circuits (ERC) 510 and 560 are respectively disposed on the scan side and the bulk side of the plasma display panel. In the positive discharging period, before the switch SW3 is turned on, the switches SW1 and SW5 (the switches SW2, SW4, SW6 SW9 are turned off) are made to turn on. Thus, the weak discharge energy stored inside the capacitor Css of the energy recovery circuit 510 will be released to a first terminal of the display unit 540 through the switch SW1, the diode D1 and the inductor L1. Using the resonance between the capacitor Cp and the inductor L1, the released weak discharge energy drives the display unit voltage Vp through a predetermined ramp voltage. Thus, power loss resulting from a large voltage difference when the switch SW3 is turned on is minimized. When the switch SW3 is turned on, the switch SW1 is turned off. After the switch SW3 is turned off, the switch SW2 is made to turn on. As a result, the energy within the capacitor Cp is returned to the capacitor Css through the inductor L1, the diode D2 and the switch SW2. Consequently, the terminal voltage Vss of the capacitor Css in the energy recovery circuit 510 is returned to the original level (for example, half of the sustain voltage Vs).

In the negative discharge period of the sustaining period, before the switch SW6 is turned on, the switches SW4 and SW8 are made to turn on (the switches SW1˜SW3, SW5, SW7 and SW9 are turned off). Thus, the weak discharge energy stored inside the capacitor Css of the energy recovery circuit 560 will be released to a second terminal of the display unit 540 through the switch SW8, the diode D3 and the inductor L2. Using the resonance between the capacitor Cp and the inductor L2, the released weak discharge energy drives the display unit voltage Vp through a predetermined ramp voltage. Thus, power loss resulting from a large voltage difference when the switch SW6 is turned on is minimized. When the switch SW6 is turned on, the switch SW8 is turned off. After the switch SW6 is turned off, the switch SW7 is made to turn on. As a result, the energy within the capacitor Cp is returned to the capacitor Css through the inductor L2, the diode D4 and the switch SW7. Consequently, the terminal voltage Vss of the capacitor Css in the energy recovery circuit 560 is returned to the original level (for example, half of the sustain voltage Vs).

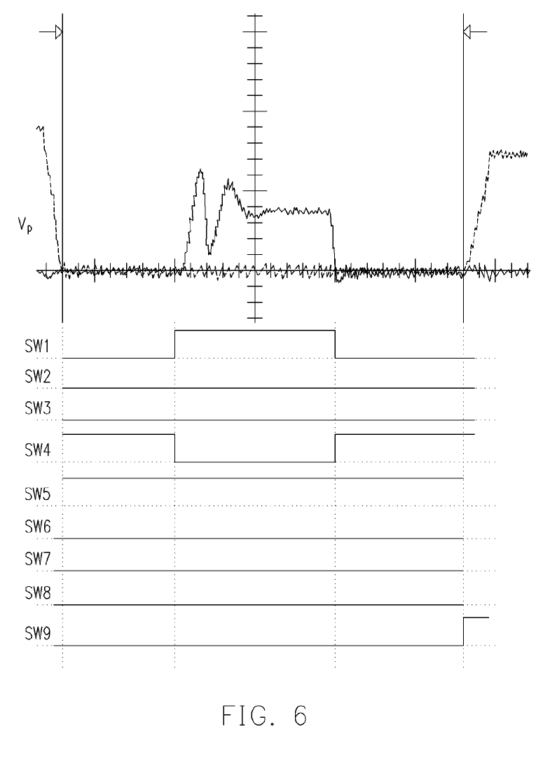

FIG. 6 is a diagram showing the on-off timing relation of the switches and the voltage of the display unit in FIG. 5 during the resetting period according to one embodiment of the present invention. As shown in FIGS. 5 and 6, the switches SW2˜SW3 and SW7˜SW9 are cut off during the resetting period. In the resetting period, the first terminal (the scan side) and the second terminal (the bulk side) of the display unit 540 are reset in sequence. In the following, the operation for resetting the scan side is described. However, by induction, anyone familiar with the technique may apply the same operation to reset other circuits.

The reset circuit responsible for resetting (erasing) the various display units 530 of the plasma display panel during the resetting period includes the energy recovery circuit 510. In the first period of the resetting period (the period for resetting the first terminal of the display unit 540), weak discharge energy is provided to the first terminal of the display unit 540 by means of resonance. During this period, the second terminal of the display unit 540 is made to electrically connect with a first fixed voltage (here, a ground voltage) through the switch SW5. In the present embodiment, the resonance function is provided by serially connecting an inductor and a capacitor together. However, anyone familiar with the technique may produce the same resonance effect by connecting components in parallel instead.

Before resetting the scan side, the switches SW4 and SW5 are made to turn on (all the other switches are cut off) and the scan side and bulk side of the display unit 540 are connected to the ground. After turning off the switch SW4, the first switch (the switch SW1) of the energy recovery circuit 510 is made to turn on. Thus, the weak discharge energy stored inside the capacitor Css of the energy recovery circuit 510 will be released to a first terminal of the display unit 540 through the switch SW1, the diode D1 and the inductor L1. Using the resonance between the capacitor Cp and the inductor L1, the released weak discharge energy can reset the display unit 540. After turning off the switch SW1, the first period of the resetting period ends. Thereafter, the switch SW is made to turn on again so that the first terminal of the display unit 540 is electrically connected to a ground voltage.

In the present embodiment, the resonance between the capacitor Cp and the inductor L1 is used to provide weak discharge energy for resetting the display unit 540. Hence, the potential of the display unit voltage Vp in the present embodiment is far lower than the reset potential in the conventional technique. Consequently, a large portion of the background light is trimmed. Furthermore, the time required spent in the resetting operation is much shorter than the conventional technique because there is no need to slowly raise the potential of the display unit to the reset voltage level. Some experimental data is shown in Table 1 below.

TABLE 1
A comparison between the conventional technique and the method in the
present embodiment.

| | Full black | | |
|---|---|---|---|
| | average | | |
| | brightness | Full black Watt | Resetting time |
| Conventional | 0.6711 cd/m² | 85 Watts | 42 μs |
| technique | | | |
| The embodiment | 0.5633 cd/m² | 85 Watts | 4 μs |
| in the present | | | |
| invention | | | |

In the second period of the resetting period (the period for resetting the second terminal of the display unit 540), the following method can also be used to reset the second terminal of the display unit 540 beside the aforementioned method. In other words, the reset circuit may include a pull-down circuit 520. The pull-down circuit 520 is electrically connected to the first terminal of the display unit 540. In the second period of the resetting period, the switches SW6 and SW9 are made to turn on (turning off other switches). The pull-down circuit 520 slowly pulls down the voltage at the first terminal of the display unit 540 to a second voltage (for example, a negative voltage Vx). Meanwhile, the second terminal of the display unit 540 is electrically connected to a third fixed voltage (the sustain voltage Vs). With the resistor R1 controlling the voltage increasing speed of the display unit voltage Vp, the capacitor Cp is charged to produce a weak discharge for erasing wall charge and resetting the plasma display panel.

In summary, the present invention utilizes the resonance in an energy recovery circuit to provide the weak discharge energy necessary for resetting (or erasing wall charge) a PDP to the display unit during the resetting period. Therefore, redundant components in the reset circuit can be eliminated to reduce production cost. Moreover, the time and the potential for completing a resetting operation when the energy recovery circuit provides weak discharge energy are far shorter and smaller than the prior technique. Hence, the background illumination can be substantially reduced. In the meantime, because the present invention is able to reduce the resetting period significantly, the sustaining period can be increased. As a result, the color display can be increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A circuit for resetting a plasma display panel, for resetting at least one display unit in a plasma display panel during a resetting period, the reset circuit comprising:
at least an energy recovery circuit for providing discharge energy to a first terminal of the display unit by means of resonance during a first period of the resetting period;
wherein a second terminal of the display unit is electrically connected to a first fixed voltage during the first period of the resetting period.

2. The reset circuit of claim 1, wherein the energy recovery circuit further includes storing the discharge energy from the first terminal of the display unit and providing the discharge energy to the first terminal of the display unit through the means of resonance during a sustaining period.

3. The reset circuit of claim 1, wherein the first fixed voltage is a ground voltage.

4. The reset circuit of claim 1, wherein the means of resonance is obtained through a serially connected inductor-capacitor system.

5. The reset circuit of claim 1, wherein the energy recovery circuit comprises:
a capacitor for storing the discharge energy;
a first switch having a first terminal electrically connected to the capacitor for channeling the discharge energy to a second terminal of the first switch during the first period of the resetting period;
a diode having an anode electrically connected to a second terminal of the first switch; and
an inductor having a first terminal electrically connected to the cathode of the diode,
wherein a second terminal of the inductor is electrically connected to the first terminal of the display unit.

6. The reset circuit of claim 1, wherein the circuit further comprises:
a pull-down circuit electrically connected to the first terminal of the display unit for pulling down the first terminal of the display unit to a second voltage during a second period of the resetting period;
wherein the second terminal of the display unit is electrically connected to a third fixed voltage during the second period of the resetting period.

7. The reset circuit of claim 6, wherein the second voltage is lower than the third fixed voltage.

8. The reset circuit of claim 7, wherein the second voltage is a negative voltage and the third fixed voltage is a sustain voltage.

9. The reset circuit of claim 6, wherein the pull-down circuit comprises:
a resistor having a first terminal electrically connected to the first terminal of the display unit; and
a second switch having a first terminal electrically connected to a second terminal of the resistor and a second terminal of the second switch electrically connected to the second voltage.

10. A method for resetting a plasma display panel having at least a display unit, the resetting method comprising:
providing discharge energy to a first terminal of the display unit by means of resonance in a corresponding energy recovery circuit during a first period of a resetting period;
wherein a second terminal of the display unit is electrically connected to a first fixed voltage during the first period of the resetting period.

11. The reset method of claim 10, wherein the energy recovery circuit further stores the discharge energy in a sustaining period and provides the discharge energy to the first terminal of the display unit during the sustaining period.

12. The reset method of claim 10, wherein the first fixed voltage is a ground voltage.

13. The reset method of claim 10, wherein the energy recovery circuit is a serially connected inductor-capacitor resonance circuit for providing the discharge energy.

14. The reset method of claim 10, wherein the energy recovery circuit comprises:
a capacitor for storing the discharge energy;
a first switch having a first terminal electrically connected to the capacitor for channeling the discharge energy to a second terminal of the first switch during the first period of the resetting period;
a diode having an anode electrically connected to a second terminal of the first switch; and
an inductor having a first terminal electrically connected to the cathode of the diode,
wherein a second terminal of the inductor is electrically connected to the first terminal of the display unit.

15. The reset method of claim 10, wherein the method further comprises the steps of:
pulling down the first terminal of the display unit to a second voltage in a second period of the resetting period; and
coupling the second terminal of the display unit to a third fixed voltage in the second period of the resetting period.

16. The reset method of claim 15, wherein the second voltage is lower than the third fixed voltage.

17. The reset method of claim 16, wherein the second voltage is a negative voltage and the third fixed voltage is a sustain voltage.
